(19) United States
(12) Patent Application Publication
(10) Pub. No.: US 2007/0000096 A1
(43) Pub. Date: Jan. 4, 2007

(54) Bakeware set and bakeware grips

(75) Inventor: William J. Lazaroff, Floral Park, NY (US)

Correspondence Address: JENKENS & GILCHRIST, PC, 1445 ROSS AVENUE, SUITE 3200, DALLAS, TX, 75202, US

(73) Assignee: Lifetime Hoan Corporation, Westbury, NY (US)

(21) Appl. No.: 11/148,065

(22) Filed: Jun. 8, 2005

(51) Int. Cl. A47J 45/10

(52) U.S. Cl. 16/435

(57) ABSTRACT

A bakeware set including a bakeware dish having at least one handle. The bareware set further includes a flexible hand grip that is slipped over the handle to be retained thereon by friction contacts.

### BACKGROUND OF THE INVENTION

1. Technical Field

The present invention relates in general to hand grips for bakeware dishes and/or cooking utensils. In particular, the present invention relates to a C-shaped hand grip which increases the ability of a user to grip an object securely while simultaneously protecting the user's hand from a heated surface of the object. The C-shaped hand grip slips over bakeware dish handles and/or cooking utensil handles in a preferred implementation.

2. History of Related Art

The gripping of objects could be considered an important aspect of everyday life due to the simple fact that people use their hands to grip objects all the time during the course of the day. Oven mitts, pot holders, and dish holders are most commonly used for holding heated kitchen utensils and bakeware dishes. Since oven mitts are usually large and clumsy, a user may find it difficult to securely grip the object and further may need help from their other hand to put on the oven mitt. Pot holders do not cover the area to be held very well and can easily slip. Thus, the user's hand is susceptible to the heated utensils unless extra caution is exercised by the user while using oven mitts and pot holders. Hence, neither oven mitts nor pot holders provide a safe and convenient mechanism for handling cooking utensils and bakeware dishes.

In another approach, gloves are frequently used to protect hands from heated surfaces and enhance gripping. Gloves used for such purposes may suffer from bunching of the material from which they are constructed, causing discomfort. In addition, gloves are prone to deterioration and can be unhygienic when used repeatedly. Furthermore, gloves must be sized to exactly fit the user's hand to provide the user with grip enhancing capabilities and protection from heat.

None of the prevalent prior art solutions provide an effective means for gripping and protecting a user's hand during the process of cooking, serving food, or other activities especially in situations where the user needs to hold bakeware dishes and/or cooking utensils.

Therefore, there is a need for a flexible heat resistant hand grip that can be easily slipped over handles of bakeware dishes and/or cooking utensils along with being simple and inexpensive to manufacture.

### SUMMARY OF THE INVENTION

A bakeware set includes a bakeware dish having at least one handle and a flexible hand grip that is slipped over the handle to be retained thereon by friction contact.

A bakeware set includes a bakeware dish having at least one handle, the handle including a depression region on an underside of the handle. The bakeware set further includes a flexible hand grip having a substantially C-shaped body adapted to slip over the handle causing a first pad region on a surface of a first wall at an interior region of the C-shaped body to slip into the depression region on the underside of the handle.

A bakeware set includes a bakeware dish having at least one handle, the handle including a top wall and a bottom wall. The bakeware set further includes a flexible hand grip having a substantially C-shaped body adapted to slip over the handle causing a plurality of flaps on a surface of a first wall at an interior region of the C-shaped body to come in contact with the bottom wall of the handle.

A flexible hand grip for sliding over a handle of a bakeware dish includes a generally C-shaped body. The grip further includes a first pad region on a surface of a first wall at an interior region of the C-shaped body and a second pad region on a surface of a second wall at the interior region of the C-shaped body. A thickness of the first pad region is substantially greater than a thickness of the second pad region.

### BRIEF DESCRIPTION OF THE DRAWINGS

A more complete understanding of the present invention may be obtained by reference to the following Detailed Description of Illustrative Embodiments of the Invention, when taken in conjunction with the accompanying Drawings, wherein:

FIG. 1 is a perspective view of the C-shaped hand grip according to the present invention;

FIG. 2 is an end view of the C-shaped hand grip according to the present invention;

FIG. 3 is a side view of the C-shaped hand grip according to the present invention;

FIG. 4 illustrates a detailed view of an interior region of the C-shaped hand grip;

FIG. 5A illustrates a perspective view of a bakeware dish in combination with the C-shaped hand grip according to an embodiment of the present invention;

FIG. 5B illustrates a perspective view of a bakeware dish in combination with the C-shaped hand grip according to an alternate embodiment of the present invention; and

FIG. 6 is a cross-sectional view of the C-shaped hand grip slipped over a handle of a bakeware dish and/or cooking utensil.

### DETAILED DESCRIPTION OF ILLUSTRATIVE EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims and the equivalents thereof.

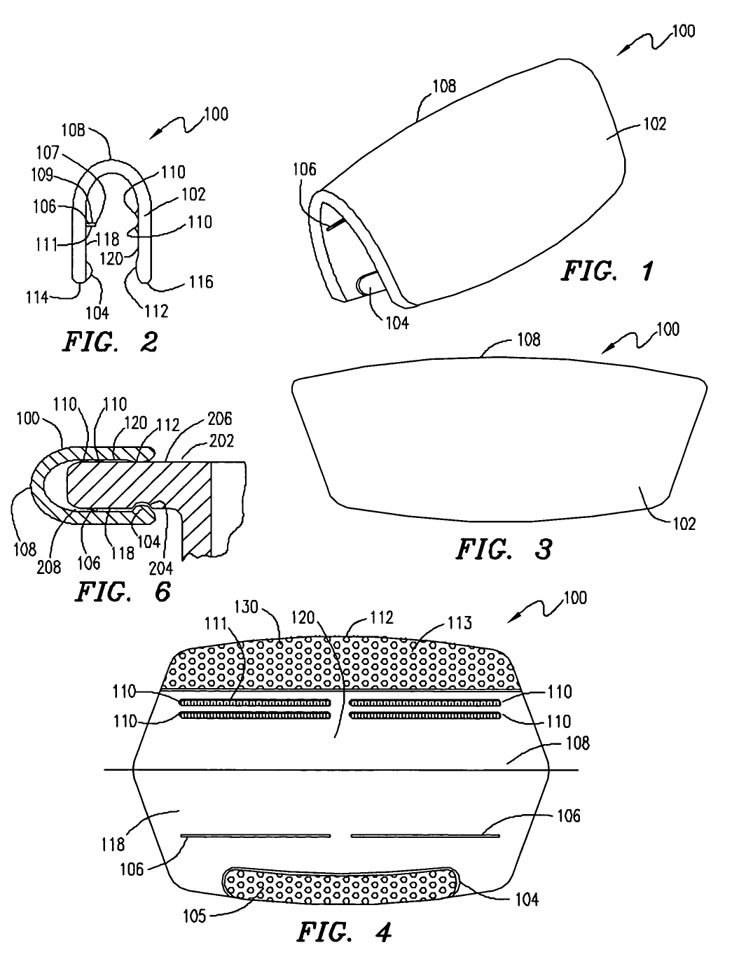

With reference now to the drawings, and in particular to FIGS. 1-6 thereof, a novel hand grip embodying the principles and concepts of the present invention and generally designated by the reference numeral 100 will be described. While the embodiments described herein are identified as an exemplary hand protector and hand grip enhancer for use during the lifting of bakeware dishes and/or cooking utensils, it will be appreciated by those skilled in the art that the present invention is not limited to grips for bakeware dishes and/or cooking utensils, and may include grips for use with a variety of pots and pans (or other heated articles) having at least one handle.

Referring now to FIGS. 1-6, an embodiment of the hand grip 100 of the present invention will be described.

The hand grip 100 includes a flexible body portion 102 having a resilient substantially C-shaped cross-section. The hand grip 100 is useful for enabling a user to better grip bakeware dishes and/or cooking utensils (or other articles) while protecting the user's hand from heat. In general, the hand grip 100 includes a hinge region 108 at the center of the C-shaped body 102. The C-shaped body 102 provides a resilient clamping structure for use in gripping onto a handle. An inner surface of the grip 100 may include at least one flap 106, a first pad region 104, a second pad region 112, and a plurality of ribs 110, each formed on an interior region of the C-shaped body 102.

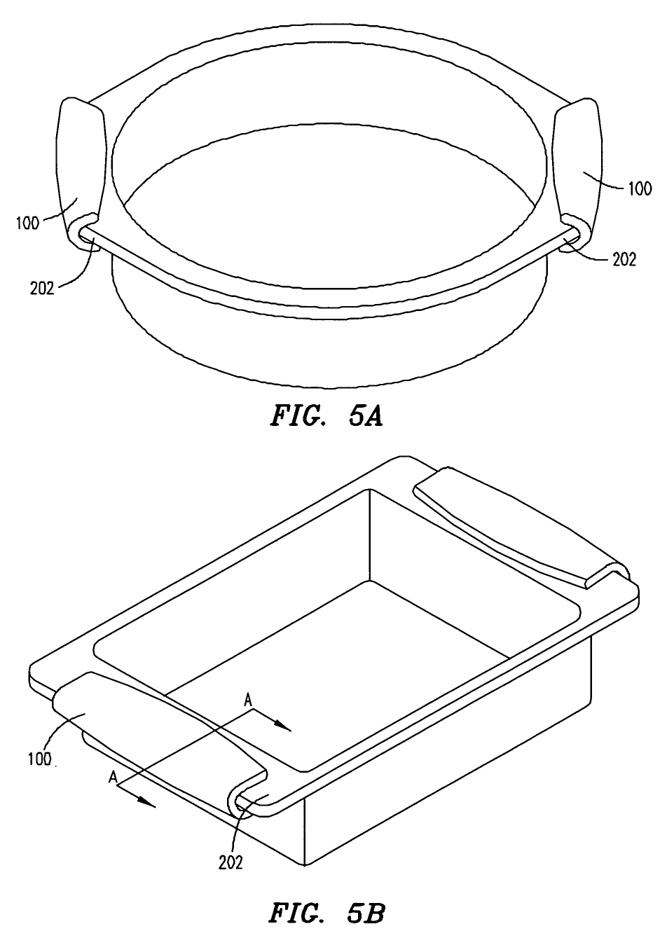

In use, the C-shaped body 102 is adapted to be slipped over a handle which can be integrated with and directed outwards from the peripheral edge of the bakeware dish and/or cooking utensil. The handle 202 (FIG. 6) provides a means for grasping and lifting the bakeware dish and/or cooking utensil. However, as this handle 202 is often hot when the bakeware is in use, it may not be grasped by a user's hand without risk of injury. By slipping the C-shaped body 102 of the grip 100 over the handle 202, the user is able to better grasp the bakeware dish and/or cooking utensil while protecting their hand from heat.

The hand grip 100 has a resilient and flexible shape and can be made of various materials which are heat resistant and flame resistant to protect the user's hand while in contact with heated surfaces. In one embodiment of the present invention, the hand grip 100 can be made of a material that is heat resistant, hygienic, and easy to clean, e.g., silicone. Although the hand grip 100 is disclosed as being formed of silicone, it will be appreciated that the hand grip 100 according to the present invention can be formed from a variety of different materials (such as elastomers, rubbers and any other material that is flexible, heat resistant and/or flame resistant).

FIG. 2 illustrates an end view of the flexible hand grip 100. The hinge region 108 has a substantially convex outer surface shape (best shown in the side view of FIG. 3). The length of the C-shaped body 102 from the hinge region 108 towards a first end 114 is substantially similar to the length of the C-shaped body 102 from the hinge region 108 towards a second end 116. FIG. 2 further illustrates, in a side view, an interior region of the hand grip 100. A first wall 118 refers to the interior surface region of the C-shaped body 102 associated with the first end 114. A second wall 120 refers to the interior surface region of the C-shaped body 102 associated with the second end 116. According to the present invention, the first and second walls 118 and 120 present interior surfaces which are utilized for friction and clamp gripping onto handles (202; FIG. 6) of bakeware dishes and/or cooking utensils.

Preferably, the interior surfaces provided by the first and second walls 118 and 120 are configured so as to assist in reducing slippage when the hand grip 100 is slipped over the handle of a bakeware dish and/or cooking utensil. The choice of material for the grip 100 (e.g., silicone or the like) provides a friction surface on the interior region to resist slippage when placed over the handle 202. According to an embodiment of the present invention, slippage reduction is further achieved by including at least one flap 106 and a first pad region 104 on a surface of the first wall 118. In addition, slippage reduction is further achieved by including a plurality of ridges 110 and a second pad region 112 on a surface of the second wall 120. The first end 114 in combination with the first pad region 104 and the second end 116 allows the hand grip 100 to stand upright. This enables the user to easily lift the hand grip 100 and slide the hand grip 100 over handles of bakeware dishes and/or cooking utensils. A detailed cross-sectional illustration of the interior region of the hand grip 100 is shown with reference to FIG. 6.

FIG. 3 illustrates a side view of the C-shaped body 102. FIG. 3 further illustrates the hinge region 108 comprising a substantially convex outer surface shape that complements the shape of the palm of a human hand.

FIG. 4 provides a detailed illustration of the interior region of the hand grip 100. In this view, the hand grip 100 has been opened up flat against its natural and resilient C-shape. The interior region illustrates an embodiment of the present invention and comprises a first wall 118 and a second wall 120. According to an embodiment of the present invention, a surface of the first wall 118 includes a plurality of flaps 106 and a first pad region 104. According to an embodiment of the present invention, the plurality of flaps 106 and the first wall 118 are integrally formed with the body 102. As an example, the first wall 118 and the plurality of flaps 106 can be molded together from a suitable silicone formulation, or an elastomer such as, for example, rubber, which is resilient and flexible while providing friction contact with handles of the bakeware dishes and/or cooking utensils.

The first pad region 104 is raised above the surface of the first wall 118 and is configured in size and shape as well as adapted in position to slip into a depression region (204; see FIG. 6) on an underside of the handle 202 of a bakeware dish and/or cooking utensil. The first pad region 104 is formed with substantially flat land 105 which provides a friction grip against a bottom surface of the bakeware handle 202 while the side edge of the first pad region 104 provides a mechanical interference against lateral movement and release of the grip 100 from the region 204 of the handle 202. In an embodiment of the present invention, the first wall 118 and the first pad region 104 are integrally formed with the body 102. As an example, the first wall 118 and the first pad region 104 can be molded together from a suitable silicone formulation, or an elastomer such as, for example, rubber, which is resilient and flexible while providing friction contact with handles of the bakeware dishes and/or cooking utensils. As an exemplary embodiment, the thickness of the first pad region 104 above the surface of the first wall 118 is approximately 2.0 mm.

The plurality of flaps 106 are raised above the surface of the first wall 118. The flaps 106 have a thin fin-like shape and comprise a tip region 107, a first side 109, and a second side 111. In an embodiment of the present invention, the first wall 118 and the flaps 106 are integrally formed with the body 102. An exemplary height of each flap 106 from the surface of the first wall 118 to the tip region 107 is approximately 4.0 mm. As an example, the first wall 118 and the flaps 106 can be molded together from a suitable silicone formulation, or an elastomer such as, for example, rubber, which is resilient and flexible while providing friction contact (through first or second side 109 and 111) with handles of the bakeware dishes and/or cooking utensils. The flaps 106 are bent when the grip 100 is slipped onto the handle 202. The flaps 106 thus present a surface (i.e., a side 109 or 111 of the flap) which serves to create better friction contact with respect to the bottom wall 208 of the handle 202.

According to an embodiment of the present invention, a surface of the second wall 120 includes a plurality of ridges 110 and a second pad region 112. According to an embodiment of the present invention, the plurality of ridges 110, the second pad region 112 and the second wall 120 are integrally formed with the body 102. As an example, the plurality of ridges 110, the second pad region 112, and the second wall 120 can be molded together from a suitable silicone formulation, or an elastomer such as, for example, rubber, which is resilient and flexible while providing friction contact with handles of the bakeware dishes and/or cooking utensils.

The plurality of ridges 110 and the second pad region 112 are raised above the surface of the second wall 220. The plurality of ridges 110 and the second pad region 112 are formed with substantially flat lands 111 and 113, respectively, which each provide a friction grip against a top surface of the bakeware handle 202. As an exemplary embodiment, the thickness of the plurality of ridges 110 above the surface of the second wall 120 is approximately 2.0 mm. In addition, the thickness of the second pad region 112 above the surface of the second wall 120 is approximately 0.8 mm. According to an exemplary embodiment, the thickness of the first pad region 104 is substantially greater than the thickness of the second pad region 112.

According to an alternate embodiment of the present invention, the surface of the first and second walls 118 and 120 especially in areas of the pad regions 104 and 112, may include a plurality of protuberances 105 and 130 (shown on the flat lands 105 and 113 of the first and second pad regions 104 and 112, respectively) of the same or different material as is used to form the body 102. The protuberances 105 and 130 are adapted to resist slippage of the grip 100 when placed over the handle 202. More particularly, the protuberances are in the form of circles. The protuberances can be oriented in different directions. Although illustrated in FIG. 4 as being substantially circular, it will appreciated that the surface protuberances according to the present invention can take a variety of shapes. Where the material with which the hand grip 100 is manufactured (for example, silicon) possesses an inherent anti-slip characteristic with respect to its surface the protuberances may not be needed.

According to embodiments of the present invention, hand grips 100 have been disclosed. The hand grips 100 are manufactured in various sizes to easily slip over handles of various sizes. However, the novel concept as discussed above can be applied to any other appliance having at least one handle such that the hand grip 100 can be slipped over the handle. As an exemplary embodiment, a few variations of bakeware are illustrated in FIGS. 5A-5B embodying the novel concept of having hand grips 100 on the handles 202 as discussed above.

FIG. 6 illustrates a cross-sectional view taken along line A-A of FIG. 5B. In this view, the cross section is taken of the C-shaped hand grip 100 slipped over a handle 202 of a bakeware dish and/or cooking utensil. The handle 202 of the bakeware dish includes a first (top) wall 206, a second (bottom) wall 208 and a depression region 204 on an underside of the handle 202. When the C-shaped hand grip 100 is slipped over the handle 202, the first pad region 104 having a substantially raised surface is adapted to slip into the depression region 204 on an underside of the handle 202. The raised surface of the first pad region 104 and the depression region 204 on an underside of the handle 202 enables the C-shaped hand grip 100 to create better friction grip and retention with respect to the handle 202 and thus prevent inadvertent slipping of the grips 100 off the handle 202. In addition, the plurality of flaps 106 are bent when the grip 100 is slipped onto the handle. When the flaps 106 come into contact with the first wall 206 of the handle, they bend in an outward direction. The plurality of flaps 106 thus present a surface (i.e., a side of the flap) which serves to create better friction contact with respect to the bottom wall 208 of the handle 202. The plurality of ridges 110 and the second pad region 112 having a substantially raised surface comes into contact with the second (bottom) wall 208 of the handle 202. The purpose of the first pad region 104, the second pad region 112, the plurality of flaps 106 and the plurality of ridges 110 are for providing friction grip surfaces with respect to the handle 202.

It should be emphasized that the terms “comprise”, “comprises”, and “comprising”, when used herein, are taken to specify the presence of stated features, integers, steps, or components, but do not preclude the presence or addition of one or more other features, integers, steps, components or groups thereof.

The previous Detailed Description is of embodiment(s) of the invention. The scope of the invention should not necessarily be limited by this Description. The scope of the invention is instead defined by the following claims and the equivalents thereof.

What is claimed is:

1. A bakeware set, comprising:
a bakeware dish having at least one handle; and
a flexible hand grip that is slipped over the handle to be retained thereon by friction contact.

2. The bakeware set of claim 1, wherein the handle is integrated with and directed outwards from a peripheral edge of the bakeware dish.

3. The bakeware set of claim 1, wherein the bakeware dish is substantially rectangular.

4. The bakeware set of claim 1, wherein the flexible hand grip comprises a generally C-shaped body that clamps around and makes friction contact with a top and bottom surface of the handle.

5. The bakeware set of claim 4, wherein the C-shaped body is made of a material having low thermal conductivity.

6. The bakeware set of claim 5, wherein the material possesses an inherent anti-slip characteristic.

7. The bakeware set of claim 4, wherein the C-shaped body is heat resistant.

8. The bakeware set of claim 7, wherein the C-shaped body is made from silicone.

9. The bakeware set of claim 4, wherein the C-shaped body is made from at least one of an elastomeric material and a rubber.

10. The bakeware set of claim 4, wherein the C-shaped body is resiliently flexible about a hinge region.

11. The bakeware set of claim 10, wherein the hinge region has a substantially convex outer surface shape that complements a human hand.

12. The bakeware set of claim 10, wherein the hinge region is shaped to substantially conform to a user's palm.

13. The bakeware set of claim 4, wherein the C-shaped body further comprises a first pad region on a surface of a first wall at an interior region of the C-shaped body.

14. The bakeware set of claim 13, wherein the first pad region is raised above the surface of the first wall.

15. The bakeware set of claim 14, wherein the bakeware handle includes a depression region on an underside of the handle and the first pad region is adapted to slip into the depression region when the C-shaped body clamps around the handle.

16. The bakeware set of claim 15, wherein the first pad region comprises a plurality of protuberances.

17. The bakeware set of claim 4, wherein the C-shaped body further comprises a plurality of flaps on a surface of a first wall at an interior region of the C-shaped body.

18. The bakeware set of claim 17, wherein the plurality of flaps include a tip region, a first side, and a second side.

19. The bakeware set of claim 18, wherein the plurality of flaps are bent when the C-shaped body is slipped over the handle.

20. The bakeware set of claim 19, wherein one of the first and second sides of the plurality of flaps provides a friction grip surface with respect to the handle.

21. The bakeware set of claim 4, wherein the C-shaped body further comprises a plurality of ridges and a second pad region on a surface of a second wall at an interior region of the C-shaped body.

22. The bakeware set of claim 21, wherein the second pad region is raised above the surface of the second wall.

23. The bakeware set of claim 22, wherein the the second pad region comprises a plurality of protuberances.

24. The bakeware set of claim 22, wherein a thickness of a first pad region is substantially greater than the thickness of the second pad region.

25. The bakeware set of claim 10, wherein the C-shaped body is symmetrical about the hinge region.

26. The bakeware set of claim 1, wherein the first and second ends enable the flexible hand grip to free stand in an upright position.

27. A bakeware set, comprising:
a bakeware dish having at least one handle, the handle including a depression region on an underside of the handle; and
a flexible hand grip having a substantially C-shaped body adapted to slip over the handle causing a first pad region on a surface of a first wall at an interior region of the C-shaped body to slip into the depression region on the underside of the handle.

28. A bakeware set, comprising:
a bakeware dish having at least one handle, the handle including a top wall and a bottom wall; and
a flexible hand grip having a substantially C-shaped body adapted to slip over the handle causing a plurality of flaps on a surface of a first wall at an interior region of the C-shaped body to come in contact with the bottom wall of the handle.

29. A flexible hand grip for sliding over a handle of a bakeware dish, comprising:
a generally C-shaped body;
a first pad region on a surface of a first wall at an interior region of the C-shaped body;
a second pad region on a surface of a second wall at the interior region of the C-shaped body; and
wherein a thickness of the first pad region is substantially greater than a thickness of the second pad region.

30. The grip of claim 29, wherein the first pad region is sized and shaped to complementarily fit into a depression formed on a surface of the bakeware dish handle.

31. The grip of claim 29, wherein second pad region is sized and shaped to complementarily fit into a depression formed on a surface of the bakeware dish handle.

32. The grip of claim 29, further including a plurality of flaps on the surface of the first wall.

33. The grip of claim 29, further including a plurality of ridges on the surface of the second wall.

34. The grip of claim 29, further including a plurality of protuberances on the surface of the first and second walls.
